(19) United States
(12) Patent Application Publication
(10) Pub. No.: US 2006/0095469 A1
(43) Pub. Date: May 4, 2006

(54) System and method for facilitating peer review of a deliverable

(76) Inventors: Jeffrey H. Willy, Fort Collins, CO (US); Paul W. VanLeer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/978,329

(22) Filed: Nov. 1, 2004

(51) Int. Cl. G06F 17/00

(52) U.S. Cl. 707/104.1

(57) ABSTRACT

A system and method for facilitating peer review of a deliverable. One embodiment may comprise communicating a deliverable to at least one peer; receiving an issues database generated by the peer's processing system, the issues database having information identifying at least one issue raised by the peer, information identifying a location of the issue, information corresponding to a comment made by the peer pertaining to the issue, and information identifying the peer; integrating the information in the received issues database into corresponding information in a master issues database; and associating location of the issue with an issue flag when the a peer review deliverable is displayed, the peer review deliverable corresponding to both the deliverable and the information of the master issues database.

### TECHNICAL FIELD

Embodiments are generally related to document review and, more particularly, is related to a system and method facilitating peer review of a deliverable.

### BACKGROUND

Deliverables, such as documents or program code, are typically reviewed by peers before release of the deliverable. Peers are typically individuals who are familiar with the technology associated with the deliverable. Peers review the deliverable to identify potential errors and/or to suggest improvements to the deliverable. Such potential errors and/or improvements may be collectively referred to as issues.

The peer review process is initiated when the author(s) of the deliverable submits the deliverable to the peers for review. Peers then inspect the deliverable and note any issues that they discover. Typically, the peers note the location of the issue in the deliverable (for example, by page and/or line number), and then provide comments regarding the nature of the identified issue. The peers, after completing their review of the deliverable, then provide their noted issues and issue comments to the author.

The author may then address each of the issues. Often, based on the issue comments provided by the peers, the author may revise the deliverable. Or, a meeting among the author(s) and the peers may be held to discuss issues and to identify possible issue solutions.

In some situations, the peers manually identify issues and manually provide issue comments. For example, one peer may review the deliverable, and take copious hand-written notes, or create the notes using a word processing application. The notes can then be sent to the author for review.

In other situations, peers may electronically identify issues and insert issue comments directly into the deliverable when the deliverable is provided to the peers using a word processing application. For example, issues may be identified using a notes feature or the like, by highlighting areas of the deliverable, and/or by adding special flags or icons into the deliverable using standard features of the word processing application. When the author reviews the returned deliverable from the peer, the word processing application displays the various indicators showing the location of the issue in the deliverable. Then, the textual comment associated with each issue is accessed by the author. However, the deliverable has been modified with the issue comments and other information. Often, such data files associated with the returned deliverable are very large and unwieldy.

Often the peer review process is iterative. Identified issues and issue comments are compiled together. Often, the author's proposed issue solution is included in the compilation. After compilation, the totality of the issues, issue comments and proposed issue solutions are resubmitted to the peers for further review and comment. Then, the peers provide a subsequent set of issue comments where appropriate.

Typically, such subsequent peer review occurs after the peers have completed their initial review. Thus, a peer cannot be biased during their initial review by any issues and/or issue comments from other peers because they initially do not have access to issues identified by the other peers.

An iterative peer review process is desirable in that several peers may identify a common issue, yet provide dissimilar issue comments. Or, some peers may have missed issues identified by other peers. With an iterative peer review process, the author and/or peers may later consider the totality of the identified issues and issue comments, and then synergistically develop an optimal solution for each of the issues. If the author provides a proposed issue solution, peers may offer additional suggestions to the proposed issue solution.

In one exemplary peer process, the author compiles all of the issues and issue comments provided by the plurality of peers into a separate document or source, and then distributes the compiled issues and issue comments to the peers. The author's proposed issue solutions may also be included. Special peer review applications have been developed to facilitate this type of peer review process. Using a specialized peer review application may be desirable in that the issues, issue comments and proposed issue solutions are not directly incorporated into the deliverable itself. However, a separate copy of the deliverable must be available to the reviewer so that the reviewer may understand the contextual nature of the issues, issue comments and proposed issue solutions. Accordingly, considerable time and effort may be spent by the author and peers in coordinating a subsequent review between the compiled document or source (having the totality of the issues, issue comments and proposed issue solutions) and the separate copy of the deliverable.

In another exemplary iterative peer review process, the author incorporates the issues and issue comments provided by the plurality of peers into the deliverable itself using the word processing application. With some word processing applications, the compilation may be performed automatically. The annotated deliverable can then be conveniently distributed to the peers for subsequent review and comment. During the subsequent review, the peers may directly provide comment into the deliverable itself. However, the separate documents having the subsequent comments, after being returned to the author, must be recompiled into a single version of the deliverable. Also, the annotations (issues, issue comments and proposed issue solutions) in the deliverable may be undesirable in the final deliverable. Accordingly, considerable time and effort may be spent by the author to remove the annotations before release of the final deliverable.

The above-described peer review processes are known to be tedious and labor intensive. Furthermore, lengthy turn-around times are often encountered between solicitation of peer review, compilation of the identified issues and issue comments into a common source, subsequent distribution to the peers for additional review, and final resolution of the issues via the author's proposed issue solutions.

### SUMMARY

Various embodiments provide a system and method for facilitating peer review of a deliverable. One embodiment may comprise communicating a deliverable to at least one peer; receiving an issues database generated by the peer's processing system, the issues database having information identifying at least one issue raised by the peer, information identifying a location of the issue, information corresponding to a comment made by the peer pertaining to the issue, and information identifying the peer; integrating the information in the received issues database into corresponding information in a master issues database; and associating location of the issue with an issue flag when the a peer review deliverable is displayed, the peer review deliverable corresponding to both the deliverable and the information of the master issues database.

Another embodiment may comprise receiving a deliverable from an author; saving the received deliverable as a peer review deliverable; identifying at least one issue in the peer review deliverable; specifying a location of the issue in the peer review deliverable; providing an issues comment pertaining to the issue; integrating at least information corresponding to the issues comment, information corresponding to the location, and information corresponding to an identity of the peer into an issues database; and associating location of the issue with an issue flag, the issue flag displayed concurrently with display of the peer review deliverable, wherein the peer review deliverable corresponds to both the received deliverable and the information of the issues database.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating an embodiment of an integrated peer review tool.

FIG. 2 is a block diagram illustrating multiple embodiments of the integrated peer review tool implemented in a plurality of processing systems to facilitate peer review among a plurality of peers and the author of the deliverable.

FIGS. 3A-3L further illustrate the peer review process using embodiments of the integrated peer review tool.

FIG. 4 illustrates an integrated master issues database.

FIGS. 5A-5E illustrate the author's review process of identified peer issues using embodiments of the integrated peer review tool.

FIG. 6 illustrates an integrated master issues database with the author's comments.

FIGS. 7A and 7B illustrate the peer's and the author's review process, after the author has provided issue solutions into the integrated master issues database.

FIG. 8 illustrates a printable version of the issues comments and the provided issue solutions.

FIG. 9 is a flowchart illustrating an embodiment of a process for facilitating peer review of a deliverable by the an author.

FIG. 10 is a flowchart illustrating an embodiment of a process for facilitating peer review of a deliverable by the a peer.

### DETAILED DESCRIPTION

The integrated peer review tool 100 provides a system and method for facilitating peer review of a deliverable. Such deliverables, for example, may be textual products or computer programming code.

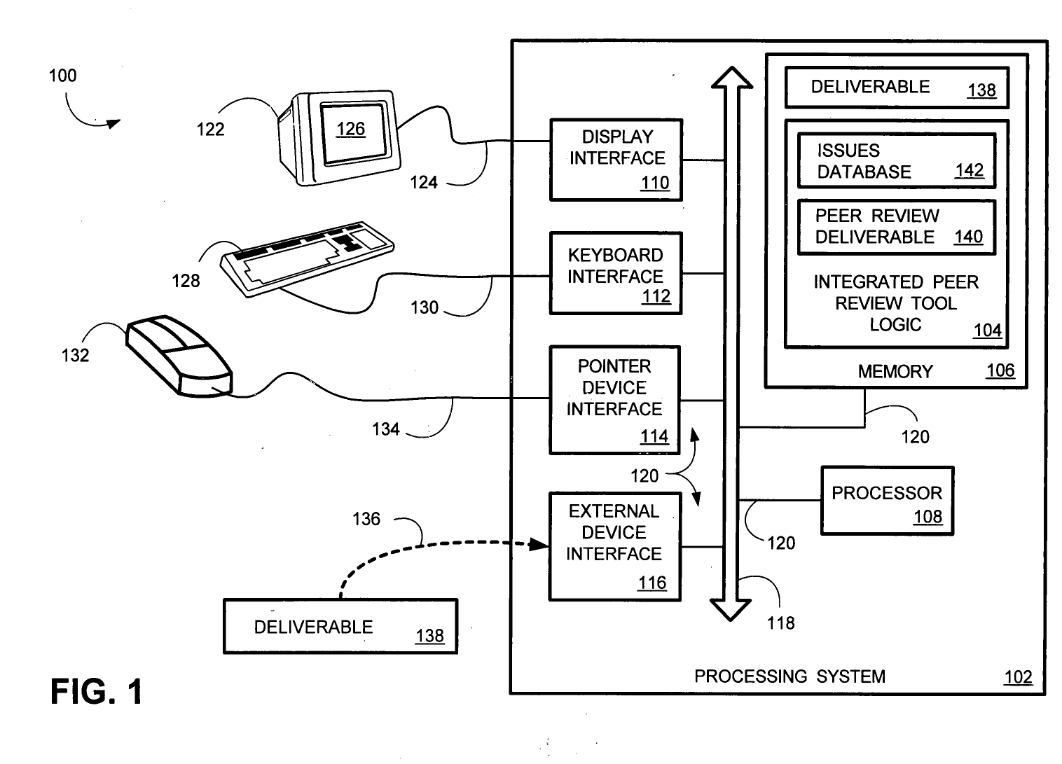

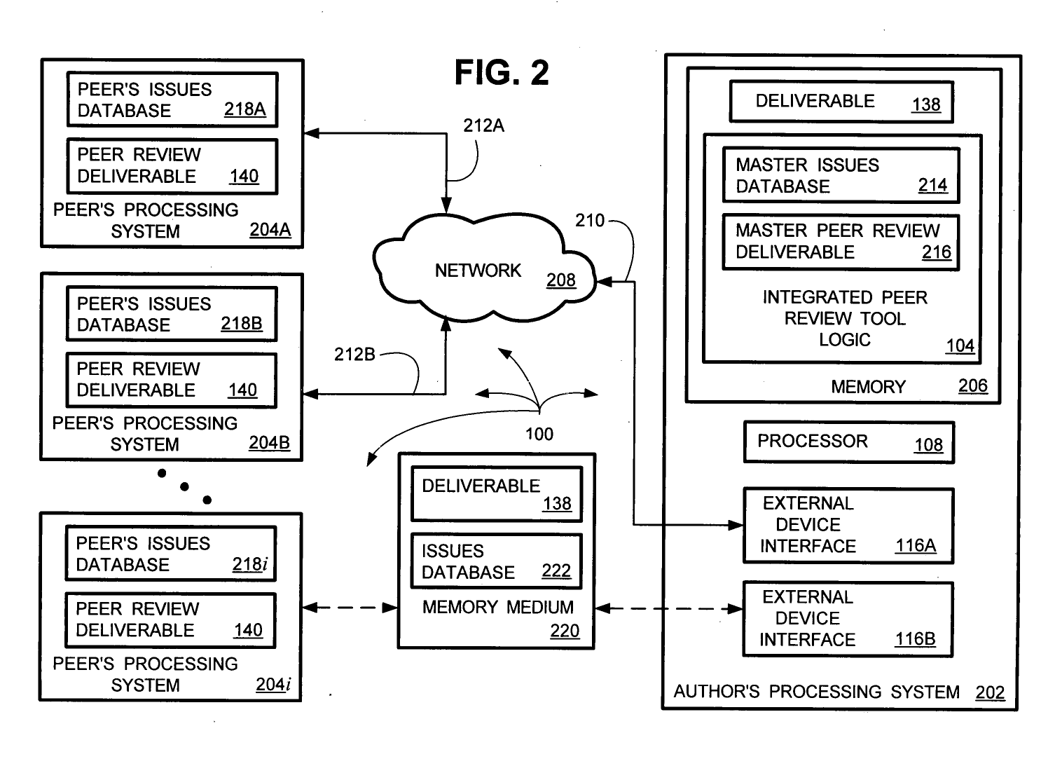

Peers use embodiments of the integrated peer review tool 100 (FIG. 1) to review, identify issues and provide issue comments regarding the deliverable under review. As each peer finishes their review of the deliverable, their peer review database, described in greater detail hereinbelow, is communicated to the author's processing system 202 for integration into the master issues database 214 (FIG. 2). The author of the deliverable may then begin his review of the issues identified by the peers (even before all of the peers have finished their review since master issues database 214 is integrated or updated as each peer finishes their review).

FIG. 1 is a block diagram illustrating an embodiment of an integrated peer review tool 100. The illustrative embodiment of the integrated peer review tool 100 is implemented in a processing system 102 as the integrated peer review tool logic 104 residing in memory 106.

Processing system 102 may be a specially designed and/or fabricated processing system, or a commercially available processor system. Non-limiting examples of commercially available processor systems include, but are not limited to, an 80×86 or Pentium series microprocessor from Intel Corporation, U.S.A., a PowerPC microprocessor from IBM., a Sparc microprocessor from Sun Microsystems, Inc., a PA-RISC series microprocessor from Hewlett-Packard Company, or a 68xxx series microprocessor from Motorola Corporation.

In one embodiment, processing system 102 includes a processor 108, a display interface 110, a keyboard interface 112, a pointer device interface 114, an external device interface 116 and memory 106. Processor 108, display interface 110, keyboard interface 112, pointer device interface 114, external device interface 116 and memory 106 are communicatively coupled through communications bus 118, via connections 120, thereby providing connectivity between the above-described components. In alternative embodiments of processing system 102, the above-described components are connectively coupled in a different manner than illustrated in FIG. 1. For example, one or more of the above-described components may be directly coupled to each other or may be coupled to each other via intermediary components (not shown).

Display interface 110 communicatively couples a display device 122, via connection 124, to processing system 102. Various displays prepared by the integrated peer review tool logic 104 may be communicated to the display device 122 and displayed on display 126 to the deliverable author or to a peer, as described in greater detail below.

Keyboard interface 112 communicatively couples a keyboard 128, via connection 130, to processing system 102. Accordingly, information may be provided by the author or by a peer for operation of the integrated peer review tool logic 104, as described in greater detail below.

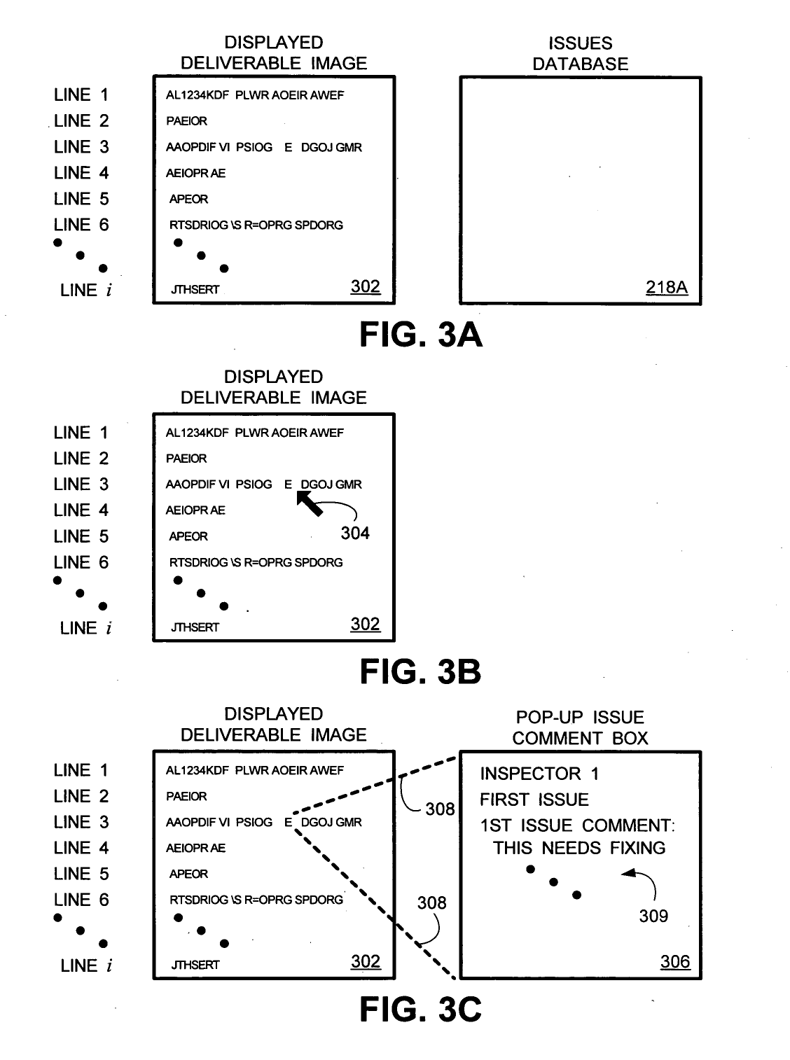

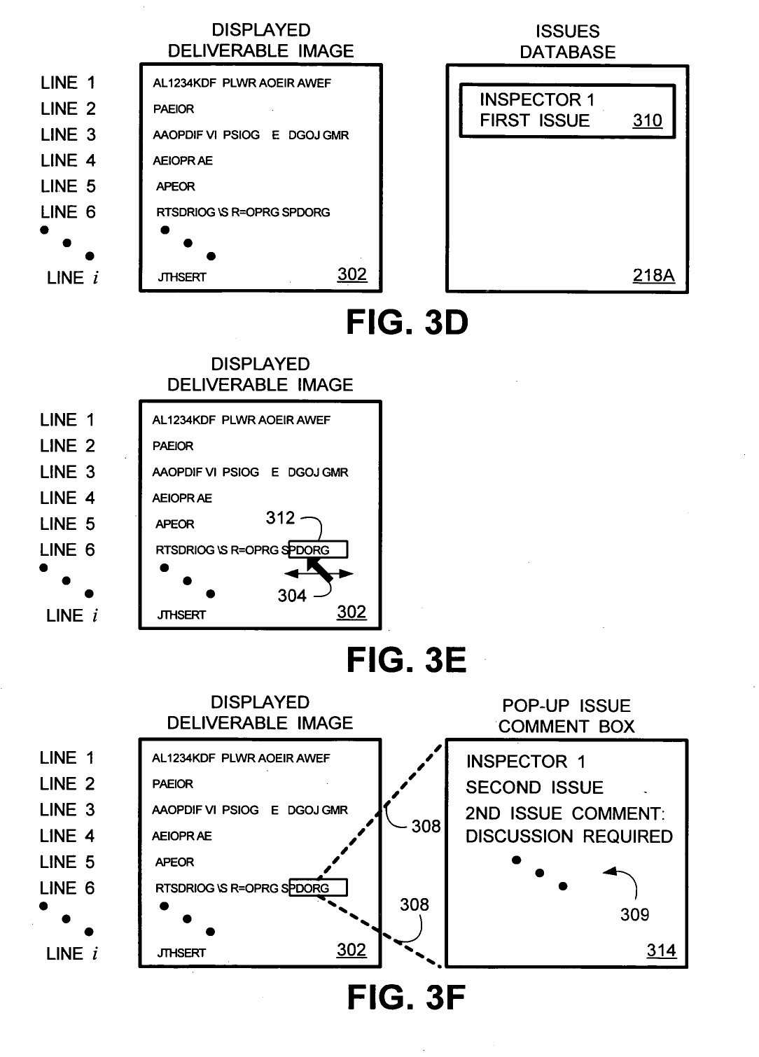

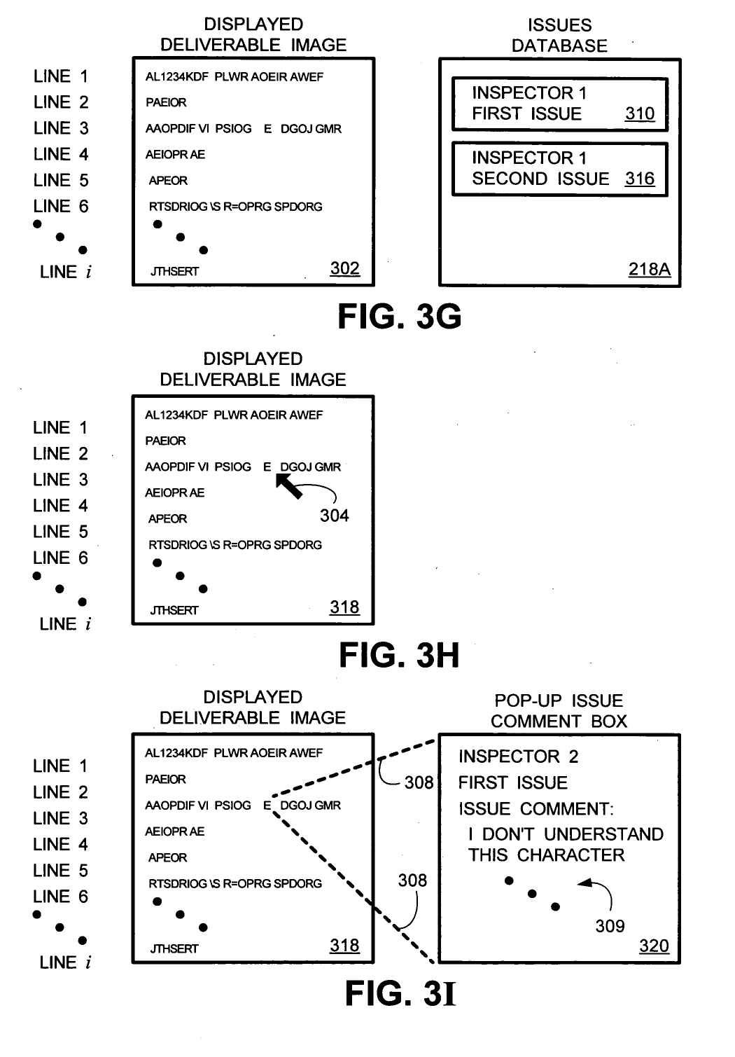

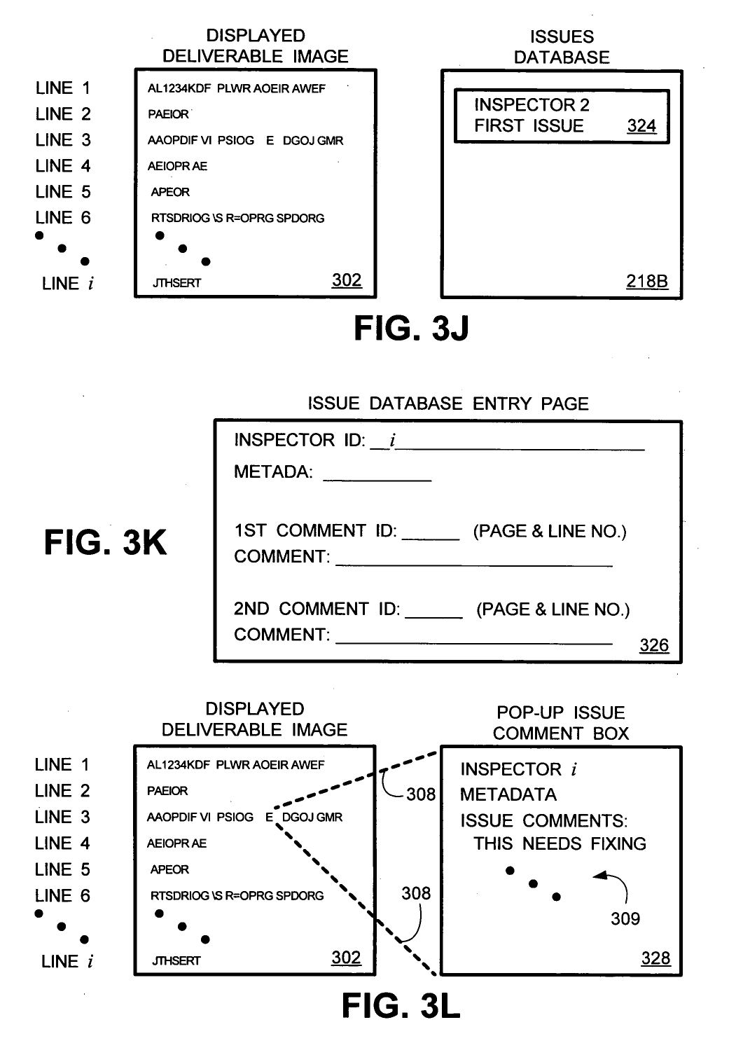

Pointer device interface 114 communicatively couples a pointer device 132, via connection 134, to processing system 102. For example, the pointer device 132 may be a conventional “mouse” device. Accordingly, information may be interactively provided by the author or by a peer, using the pointer device 132 for pointing and highlighting operations using a pointer icon 304 (FIG. 3B or 3E, for example) or cursor displayed on display 126, as described in greater detail below. Other embodiments may employ other types of devices (not shown) for pointing and/or highlighting operations.

External device interface 116 communicatively couples an external device (not shown), via connection 136, to processing system 102. Accordingly, deliverable 138 may be communicated to the processing system 102. For example, the external device may be a memory where the deliverable 138 resides. The deliverable 138 may be downloaded from the external memory into the integrated peer review tool logic 104 (as the peer review deliverable 140, described in greater detail below) or saved into memory 106 as a copy. In other embodiments, the deliverable 138 may be communicated to the processing system 102, via external device interface 116, using an intermediary system, such as another processing system, the Internet, an intranet system, telephone system cable system or the like. Or, the external device interface 116 may be a memory device reader that reads the deliverable from the memory medium, such as a compact disk, a floppy disk, or another type of memory medium that stores the deliverable.

As noted above, embodiments of the integrated peer review tool 100 are implemented in suitable processing systems 102. The integrated peer review tool logic 104 receives and saves the deliverable 138 as a working copy, referred to as the peer review deliverable 140. As will be described in greater detail below, information received from peers during the review process (identified issues and related issue comments), and information from the author (issue solutions) are processed in an integrated fashion such that all parties can conveniently access the identified issues, the related issue comments and the related issue solutions during the various phases of the peer review process. That is, the tedious and time consuming process of manually compiling identified issues, issue comments and issue solutions into a separate document or source (which requires coordination with a separate copy of the deliverable) is no longer required since all aspects of the peer review process are handled in an integrated fashion by embodiments of the integrated peer review tool 100. Furthermore, the tedious and time consuming alternative process of compiling identified issues, related issue comments and issue solutions as annotations into a deliverable using a word processing application (and the subsequent removal of the annotations before release of the final deliverable) is no longer required since all aspects of the peer review process are handled in an integrated fashion by embodiments of the integrated peer review tool 100.

As described in greater detail below, the identified issues, related issue comments and issue solutions are saved in a coordinated fashion into the issues database 142. Location of each issue in the peer review deliverable 140 is identified using suitable issue flags and pop-up boxes. As will be described in greater detail below by example, when a peer discovers an issue, the peer simply moves a cursor and/or a pointer icon to the location of the issue in the deliverable, and actuates the pointer device 132. A pop-up box appears and the peer enters the issue comment. The integrated peer review tool logic 104 associates the location of the issue with the provided issue comment, and saves the information into the issues database 142. Additionally, other metadata may be associated with the issue and issue comment (for example, an identifier which identifies the peer providing the issue comment, date and time of the issue comment, etc.)

The integrated peer review tool logic 104 then associates the location of the issue with an issue flag (described in greater detail below) that is displayed concurrently with portions of the peer review deliverable 140. Subsequent review of the issue comment by the peer, by the author, or by another peer is conveniently enabled since the issue flag is visible on the displayed portion of the peer review deliverable 140. Thus, the viewer understands the location of an issue in the peer review deliverable 140.

In one embodiment, moving the pointer icon 308 (FIG. 3B), or a cursor (not shown), in proximity to the issue flag causes a pop-up issue comment box 306 (FIG. 3C) to be displayed. The pop-up issue comment box 306 allows the viewer see the associated issue comment and metadata. Thus, the viewer understands the issue comment pertains to a located issue in the peer review deliverable 140, and accordingly, in the deliverable 138.

FIG. 2 is a block diagram illustrating multiple embodiments of the integrated peer review tool 100 implemented in a plurality of processing systems 202 and 204A-i to facilitate peer review among a plurality of peers and the author of the deliverable 138. In this exemplary embodiment system, communications between the author's processing system 202 and the peer's processing systems 204A, 204B is over network 208, via connections 210, 212A-B. The network 208 may be an intranet, the Internet, or another suitable communication system. Accordingly, connection 210 communicatively couples the external device interface 116A to a corresponding interface (not shown) in network 208. Similarly, connections 212A, 212B couple a suitable external device interface (not shown) residing in the peer's processing systems 204A, 204B to a corresponding interface (not shown) in network 208. Such a system allows the deliverable 138 to be communicated from the author's processing system 202 to the peer's processing systems 204A, 204B; allows the master issues database 214 and/or the master peer review deliverable 216 to be communicated from the author's processing system 202 to the peer's processing systems 204A, 204B; and allows the peer's issues database 218A, 218B to be communicated from the peer's processing systems 204A, 204B to the author's processing system 202.

For illustration, a memory medium 220 may also be used to facilitate communication between the author's processing system 202 and the peer's processing systems 204i. Accordingly, the memory medium 220 is coupled into the external device interface 116B such that the deliverable 138 is saved into the memory medium 220. Then, the memory medium 220 is physically moved over to and coupled to the peer's processing system 204i such that the deliverable 138 is read from the memory medium 220 by the peer's processing system 204i. Similarly, the master issues database 214 may be saved to the memory medium 220 (as an issues database 222), and then read and saved to the peer's processing system 204i (as the peer i issues database 218i). After identifying issues and preparing issue comments (which are saved into the peer's issues database 218i), the peer's issues database 218i may be saved back into the memory medium 220 (as a new issues database 222), and then read and saved to the into the master issues database 214. (Alternatively, a different memory medium could be used.)

The peer review process will now be generally described with respect to the components illustrated in FIG. 2. Initially, deliverable 138 resides in the memory 206 in the author's processing system 202. To initiate the peer review process, the author communicates the master peer review deliverable 216 (or alternatively, the deliverable 138) to the peer's processing systems 204A, 204B through 204i (along with a suitably formatted request for peer review, such as by a separate e-mail or a telephone call to the peers).

Then, a peer operating one of the peer processing systems 204A, 204B through 204i begins the review process, the integrated peer review tool logic 104 (FIG. 1) receives and saves the received deliverable 216, 138 as the peer review deliverable 140. Any number of issues may be identified by the peer. For each identified issue, the integrated peer review tool logic 104 receives the issue comment information, provided in a textual format by the peer via keyboard 128 (FIG. 1). The text of the issue comment is displayed to the peer in the pop-up issue comment box 306 (FIG. 3C). The peer may edit the text of the issue comment box as necessary. When done, the peer causes the pop-up issue comment box 306 to close. Upon closing the pop-up issue comment box 306, the issue comment is identified with a unique identifier, associated with the location of the issue in the deliverable (and/or the peer review deliverable 140), is associated with other relevant metadata, and then is saved into the issues database 218A-i. When the peer has completed review of the peer review deliverable 140, the peer's issues database 218A-i comprises all of the issues and the associated issue comments (along with the location of the issue in the deliverable and other related metadata) from that peer.

Then, the peer's issues database 218A-i is communicated to the author's processing system 202, using one of the processes described above. For example, when the user of the peer's processing system 204A completes the review process, the peer's issues database 218A is communicated to the author's processing system 202. Similarly, when the user of the peer's processing system 204B completes the review process, the peer's issues database 218B is communicated to the author's processing system 202. Finally, when the user of the peer's processing system 204i completes the review process, the peer's issues database 218i is communicated to the author's processing system 202. Accordingly, a plurality of peer's issues databases 218A from a plurality of peers can be communicated to the author for compilation.

When the first one of the plurality of peer's issues databases 218A is received, the integrated peer review tool logic 104 is executed such that the master issues database 214 is generated. When another one of the plurality of peer's issues databases 218A is received, the integrated peer review tool logic 104 is executed such that an integrated master issues database 214 is generated by combining the information in the master issues database 214 with the newly received peer's issues database 218A-i. That is, the information in the master issues data base 214 is integrated (or updated) with the information received from the peers. The process continues until all of the peers have finished their review such that a final master issues database 214 is generated. Accordingly, this final master issues database 214 contains all identified issues, along with the associated issue comment and metadata for each identified issue.

One non-limiting example of metadata may be a severity indicator, such as a numeral, letter or other suitable identifier that indicates the severity and/or nature of the identified issue. Since the severity information is incorporated as metadata into the peer's issues databases 218, and then subsequently integrated into the master issues database 214, the author is able to view information regarding the severity of identified issues. For example, some embodiments may provide a severity summary report by clicking on an issue flag displayed on the deliverable.

At any time during the peer review process, the master issues database 214 may be communicated from the author's processing system 202 to a selected one of the peer processing systems 204A. When the master issues database 214 is received, the integrated peer review logic 104 residing in the peer's processing system 204A-i integrates and/or updates its respective peer's issues database 218A-i with the information in the master issues database 214. The peer may then view the peer review deliverable 140 on their respective display 126 (FIG. 1) to view the issues and issue comments in the received version of the master issues database 214. In some embodiments, the peer's ability to view issues and issue comments from other peers is blocked until that peer completes their initial review (thereby avoiding biasing of the reviewing peer).

FIGS. 3A-3L further illustrate the peer review process using embodiments of the integrated peer review tool 100. As noted above, the peer review process is initiated when the author communicates the deliverable 138 (FIG. 1, or the master peer review deliverable 216 of FIG. 2, depending upon the embodiment) to a peer for review. The received deliverable 138 (or 216) is saved as the peer review deliverable 140 by the integrated peer review tool logic 104 (FIGS. 1 and 2).

The first peer then displays a portion of the peer review deliverable 140 on display 126 (since the display 126 likely is not large enough to display the entire peer review deliverable 140). This portion of the peer review deliverable 140 is illustrated in FIGS. 3A-3M as the displayed deliverable image 302. For convenience, only the first six lines (Line 1 to Line 6) and a last line (Line i) are illustrated. As the peer reviews the peer review deliverable 140 (corresponding to the received deliverable 138), the peer may page down and/or scroll down through the peer review deliverable 140 to review the individual lines. For purposes of this simplified illustrative example, assume that the first peer is using the peer's processing system 204A (FIG. 2). (For convenience, the lines are illustrated as random characters, which are intended to have no meaning. In a real deliverable, the actual lines would correspond to text of a document or program.)

At this initial stage, corresponding to FIG. 3A, the first peer has not yet identified any issues. Accordingly, the issues database 218A (FIG. 2) is empty (has no data). Assume that at Line 3, the first peer determines that the character “E” is an error, or that the first peer desires to make a comment regarding Line 3 at the location of the “E” character. In one embodiment, the peer uses the pointer device 132 (FIG. 1) to position the pointer icon 304 (or a cursor) in proximity to the character “E” on Line 3. Actuation of the pointer device 132 causes the character “E” to be selected, thereby indicating to the integrated peer review logic 104 that the first peer has identified the location of a first issue. The integrated peer review logic 104 defines a suitable identifier to note the location of this first issue (such as a page number, line number and/or character position where the character “E” resides).

Next, the integrated peer review logic 104 causes a pop-up issue comment box 306 to be displayed, as illustrated in FIG. 3C. In this simplified example, a design choice for the pop-up issue comment box 306 displays the box 306 adjacent to the displayed deliverable image 302 with indicating lines 308 which indicate the location of the issue. Within the pop-up issue comment box 306 are selected information and/or metadata, and a comment region 309 for the peer to type in their issues comment. In this illustrative simplified example, the first peer is identified as “Inspector 1” and the metadata is indicated as the “First Issue” identified by the peer. The exemplary comment entered into the comment region 309 by the peer is “this needs fixing.”

It is appreciated that the pop-up issue comment box 306 may be designed to display any information relevant to that issue. For example, the first peer's name might be displayed, an employee number or other identifier may be displayed if peer anonymity is desired, or no peer identifier may be displayed. Similarly, any metadata of interest may be displayed. For example, the current time and/or date may be displayed. In other embodiments, the pop-up issue comment box 306 replaces the displayed deliverable image 302 (desirable if the size of display 126 is limited).

When the first peer has completed typing in their comment, the pop-up issue comment box 306 is closed and the issue location information, issue comment and metadata are integrated into the peer's issues database 218A. In some embodiments, the peer's issues database 218A is automatically communicated to the author's processing system 202 for integration into the master issues database 214 (FIG. 2). Closing out of the pop-up issue comment box 306 may be designed using any suitable technique. For example, movement of the cursor icon 304 may indicate that the peer has completed entering the comment to the issue. Or, a special key, such as the “tab,” the “return” key, or another predefined key may be actuated to indicate that the peer has completed entering the comment for the issue.

FIG. 3D illustrates the peer review process after the first peer has completed the first issue comment. The displayed deliverable image 302 returns (displaying their current portion of the peer review deliverable 140) on display 126 (FIG. 1). The issues database 218A (FIG. 2) is integrated (or updated) with the information pertaining to the first peer's first issue (indicated as “Inspector 1 First Issue” in box 310 for convenience).

Next, assume that at Line 6 the first reviewing peer determines that the phrase “SPDORG” is an error, or that the first peer desires to make a comment regarding Line 6 at the location of the “SPDORG” phrase. The first peer uses the pointer device 132 (FIG. 1) to position the pointer icon 304 (or a cursor) to highlight the “SPDORG” phrase on Line 6, as illustrated in FIG. 3E. For example, a click and drag operation may be used for highlighting in one embodiment. In another embodiment, a cursor may be moved to the beginning (or end) of the “SPDORG” phrase, and the phrase highlighted when the cursor is moved with the shift key depressed. Other embodiments may employ any suitable means for identifying a phrase of interest.

Accordingly, the “SPDORG” phrase is selected, thereby indicating to the integrated peer review logic 104 that the peer has identified the location of a second issue. The box 312 around the selected phrase indicates the selection in this simplified example. Other choices of design may be made, such as using colored highlighting or colored text to indicate the selection.

The integrated peer review logic 104 then defines a suitable identifier to note the location of this second issue (such as a page number, line number and/or character position where the phrase “SPDORG” resides.)

Next, the integrated peer review logic 104 causes a second pop-up issue comment box 314 to be displayed, as illustrated in FIG. 3F. In this simplified example, a design choice again displays the box 314 adjacent to the displayed deliverable image 302 with indicating lines 308 which indicate the location of the second issue. Within the pop-up issue comment box 314 are selected information and/or metadata, and a region for the peer to type in their second issues comment. In this illustrative simplified example, the metadata is indicated as the “Second Issue” identified by the peer. The exemplary comment entered into comment region 309 by the first peer is “discussion required.”

FIG. 3G illustrates the peer review process after the first peer has completed the second issue comment. The displayed deliverable image 302 returns to displaying the current portion of the peer review deliverable 140 (FIGS. 1 and 2) on display 126 (FIG. 1). The peer's issues database 218A (FIG. 2), residing in the peer's processing system 204A being used by the first peer, is integrated (or updated) with the information pertaining to the first peer's second issue (indicated as “Inspector 1 Second Issue” in box 316 for convenience). For the purposes of this simplified illustrative example, assume that the first peer (Inspector 1) only has the above-described two comments.

At some point, the deliverable 138 (or the master peer review deliverable 216, of FIG. 1 or 2, depending upon the embodiment) has been communicated to a second peer (Inspector 2) for review. For the purposes of this simplified example, assume that the second peer is operating the peer's processing system 204B (FIG. 2) having an embodiment of the integrated peer review tool 100. When the second peer initiates his review, the integrated peer review logic 104 (FIG. 1) is executed such that a peer review deliverable 104 is generated, and a portion thereof is displayed on the display 126. FIG. 3H illustrates a portion as the displayed deliverable image 318. Again, for convenience, only the first six lines (Line 1 to Line 6) and the last line (Line i) are illustrated. As the peer reviews the peer review deliverable 140 (corresponding to the received deliverable 138), the peer may page down and/or scroll down through the peer review deliverable 140 to review the individual lines.

Assume that the second peer also determines that the character “E” is an error, or that the second peer desires to make a comment regarding Line 3 at the location of the “E” character. The second peer uses their pointer device 132 (FIG. 1) to position the pointer icon 304 (or a cursor) in proximity to the character “E” on Line 3. Actuation of the pointer device 132 causes the character “E” to be selected, thereby indicating to the integrated peer review logic 104 that the second peer has identified the location of a first issue. The integrated peer review logic 104 defines a suitable identifier to note the location of this first issue identified by the second peer.

Next, the integrated peer review logic 104 causes a pop-up issue comment box 320 to be displayed, as illustrated in FIG. 31. In this simplified example, a design choice for the pop-up issue comment box 306 displays the box 306 adjacent to the displayed deliverable image 302 with indicating lines 308 which indicate the location of the issue. Within the pop-up issue comment box 306 are selected information and/or metadata, and a region for the second peer to type in their issues comment. In this illustrative simplified example, the second peer is identified as “Inspector 2” and the metadata is indicated as the “First Issue” identified by the second peer. The comment into the comment region 309 entered by the second peer is “I don't understand this character.”

FIG. 3J illustrates the peer review process after the second peer has completed their first issue comment. The displayed deliverable image 302 returns to displaying the current portion of the peer review deliverable 140 (FIGS. 1 and 2) on display 126 (FIG. 1). The issues database 218B, residing in the peer's processing system 204B (FIG. 2) being used by the second peer, is integrated (or updated) with the information pertaining to the second peer's first issue (indicated as “Inspector 2 First Issue” in box 324 for convenience). For the purposes of this simplified illustrative example, assume that the second peer (Inspector 2) only has the above-described single comment.

At some point, the deliverable 138 (or the master peer review deliverable 216, depending upon the embodiment) has been communicated to a third peer (Inspector i) for review. For purposes of this simplified example, assume that the third peer is operating the peer's processing system 204i having an embodiment of the integrated peer review tool 100. When the third peer initiates his review, the integrated peer review logic 104 (FIG. 1) is executed such that a peer review deliverable 140 is generated. However, assume that this third peer does not want to review the peer review deliverable 140 on their display 126. Rather, assume that the third peer has printed a copy of the peer review deliverable 140, and then either compiles all of their issues and issue comments into a separate document or source. For example, the third peer may hand-mark their printed copy of the peer review deliverable 140 with issue comments, or may prepare a separate sheet of issues and issue comments with suitable identifiers indicating the location of each issue.

After the third peer has completed their review, the third peer may elect to directly enter their issues and issue comments directly into the peer's issues database 218i residing in the peer's processing system 204i. (Or, more likely, will give their issues and issue comments to a proxy, such as an administrative assistant or the like, for entry directly into the issues database 142 residing in the administrative assistant's processing system.) Some embodiments of the integrated peer review tool 100 may support direct entry into an issues database 142 by providing a displayed, interactive issue database entry page.

FIG. 3K illustrates a portion of an issue database entry page 326. For convenience, only a few entry lines are illustrated. The third peer (or their proxy) initially provides their identification (by name or other suitable identifier). In an alternative embodiment, the integrated peer review tool uses a related identifier, such as an e-mail address or a device identifier, to identify that the issues and issue comments originate from the third peer. Entry of various metadata of interest may also be allowed. In some embodiments, other metadata may be automatically determined.

The issue database entry page 326 requires that the location of each issue be identified. Here, this simplified illustrative example only requires that the third peer provide a page number and line number for identification of an issue. In some embodiments, more or less specific location information may be required. (In alternative embodiments, global or general issues may be identified by a peer, as discussed in greater detail below.)

When the third peer (or their proxy) has completed manual entry of their issue and issue comments on the issue database entry page 326, the third peer (or their proxy) indicates such by closing out the issue database entry page 326. Other embodiments may use other suitable ways to indicate that the peer has completed their entries. Some embodiments may employ accuracy and/or completeness routines before closing, thereby ensuring that correct and/or adequate information has been provided. Upon closing the issue database entry page 326, the issues database (not shown) residing in the processing system being used by the third peer (or their proxy) is integrated (or updated) with the information pertaining to the third peer's issue(s).

In the various embodiments, a peer may interactively view portions of the displayed deliverable image 302. Issues previously identified (either identified interactively as in the case of the above-described first and second peers, or identified manually as in the case of the above-described third peer) may be reviewed. Each identified issue is indicated on the displayed deliverable image 302 by a suitable issue flag (described in greater detail below) that has been associated with the location of the issue in the peer review deliverable 140. The peer need only locate an issue flag of interest, such as by placing the pointer icon 304 over or in proximity to the issue flag, or by moving a cursor to or in proximity to, the issue flag. Such actions signal the integrated peer review logic 100 to display the pop-up issue comment box associated with that issue.

For example, and as illustrated in FIG. 3L, the third peer may interactively review the issues and issue comments entered manually via the issue database entry page 326 (FIG. 3K). Assume that the third peer (Inspector i) has identified the above-described character “E” on line 3 as an issue. Upon review, the pop-up issue comment box 328 associated with the character “E” on line 3 is displayed. The third peer may review the issue comment for accuracy and completeness. If the third peer desires, the issue comment and/or metadata may be modified.

When a peer completes their review (or a portion of their review), the peer's issues database 218 for that peer is communicated back to the author's processing system 202 (FIG. 2). The peer's issues database 218 includes metadata. One non-limiting example of metadata is the time spent by the peer during the review. When the peer uses the integrated peer review logic 104 as described above for the exemplary first and second peers (Inspectors 1 and 2), the integrated peer review logic 104 automatically tracks the time spent by the peer and saves the time information as metadata. The time information, after integration into the master issues database 214, may then later be used for a variety of reporting purposes.

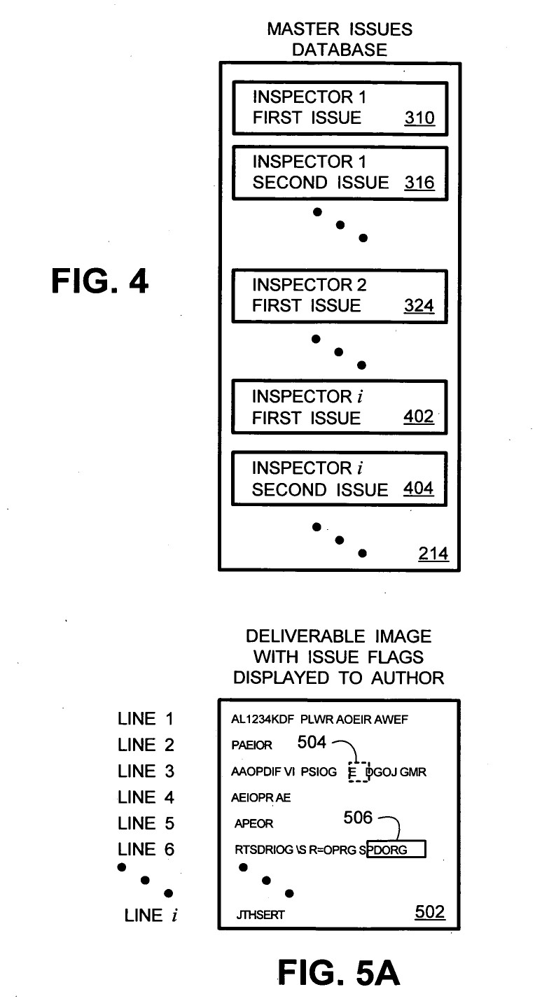

As noted above, when a peer completes their review (or a portion of their review), the peer's issues database 218 for that peer is communicated back to the author's processing system 202 (FIG. 2). The master issues database 214 is integrated (or updated) with the issues, issue comments and metadata in each received peer's issues database 218 (FIG. 2). FIG. 4 illustrates an a portion of the content of the integrated (or updated) master issues database 214 that may be displayed on one possible embodiment. Here, the master issues database 214 has been integrated (or updated) to include the above-described exemplary issues and issue comments provided by the first, second and third peers. For this illustrative example, assume that the third peer (Inspector i) has identified and provided issue comments on two issues, denoted by boxes 402 and 404. In actual practice, an integrated (or updated) master issues database 214 generated upon conclusion of the peer review process will have many identified issues (and their associated issue comments). If the deliverable project is extremely large and complex, and if many peers are involved in the peer review process, there may be thousands of identified issues.

Thus, the integrated (or updated) master issues database 214 includes box 310 (indicating a comment from Inspector 1, the above-described first peer), box 324 (indicating a comment from Inspector 2, the above-described second peer), and box 402 (indicating a comment from Inspector i, the above-described third peer), where the comments relate to the first issue associated with the character “E” as described above. Also, the integrated (or updated) master issues database 214 includes box 316 (indicating a comment from Inspector 1, the above-described first inspector) regarding the second issue associated with the phrase “SPDORG” described above. It is understood that the above-described boxes 310, 316, 324 and 402 correspond to information regarding the identified issues.

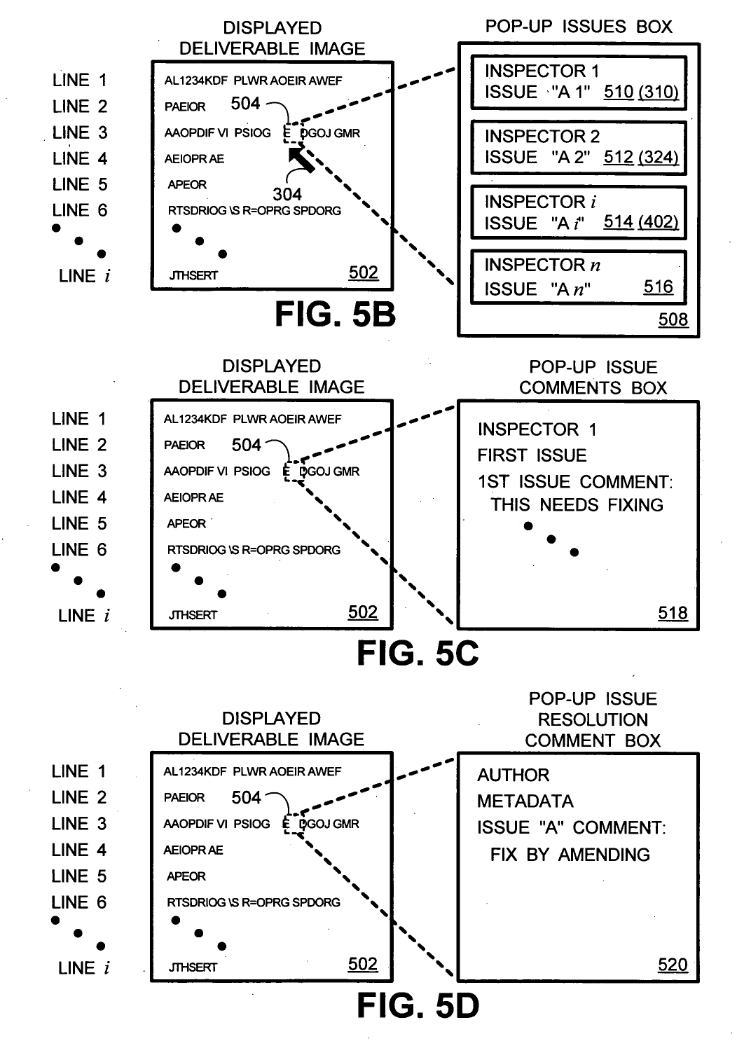

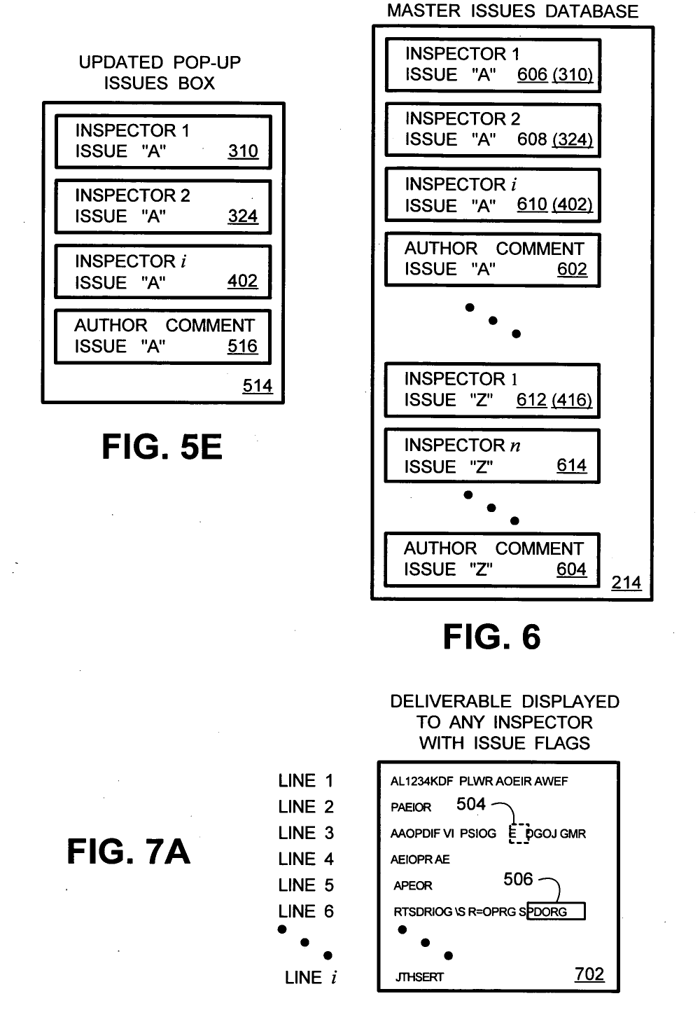

FIGS. 5A-5E illustrate the author's review process of identified peer issues using embodiments of the integrated peer review tool 100. Review by the author begins by causing the integrated peer review tool logic 104 (FIGS. 1 and 2) to integrate the identified issues (and their associated issue comments and metadata) into the master peer review deliverable 216 (FIG. 2). A portion of the master peer review deliverable 216 is illustrated in FIG. 5A as being displayed with issue flags 504 and 506. For convenience, only the first six lines (Line 1 to Line 6) and the last line (Line i) are illustrated. As the author reviews the master peer review deliverable 216 (corresponding to the received deliverable 138 integrated with all received issues), the author may page down and/or scroll down through the deliverable image to review individual lines.

The location of each issue is identified with an issue flag. Here, a box-like icon 504 indicates that the character “E” was identified as an issue. The issue flag 504 only indicates that at least one peer identified the character “E” as an issue, although according to our simplified example, the character “E” was identified as an issue by the first, second and third peers in the above-described simplified example. Also, a highlight-like icon 506 indicates that the “SPDORG” phrase was identified as an issue by at least one peer (by the first peer in the above-described simplified example). The nature and/or appearance of an issue flag may be a design choice. Thus, any suitable indicator may be used as an issue flag, such that a viewer (here, the author) understands that there is an issue, and understands the location of the issue relative to the deliverable 138.

When the author selects the flag icon 504, as illustrated in FIG. 5B, a pop-up issues box 508 is displayed. The flag icon 504 may be selected in any variety of manners, depending upon the embodiment. The author selects an issue flag of interest by placing the pointer icon 304 over or in proximity to the issue flag 504, or by moving a cursor (not shown) to, or in proximity to, the issue flag 504, or by using another suitable selection process. Such actions signal the integrated peer review logic 100 to display the current pop-up issue comment box associated with the selected issue.

In this simplified illustrative example, the pop-up issues box 508 indicates that the character “E” was identified as an issue by the first, second and third peers in the above-described simplified example. If other peers had also indicated that the character “E” was an issue, they would also be identified in the pop-up issues box 508. In this exemplary embodiment, the issue associated with the character “E” is identified as issue “A” for convenience.

In the simplified example of FIG. 5B, the numbers (such as the “1” in “A1”) indicate that there may be distinctions between the nature of the issues identified by different peers, which may be tracked by some embodiments. For example, Inspector 1 may have determined that their issue (A1) was a very severe error, such as a fatal coding error. Alternatively, Inspector 2 may have determined that their issue (pertaining to the same location in the deliverable) was a less severe error of a different type, such as a spelling error. Such embodiments may provide various summary reports, such as by the severity of an issue or by the type of an issue.

Since box 510 corresponds to the information from Inspector 1 (the above-described first peer on the issue relating to the character “E”), box 510 corresponds to the information of box 310 (FIGS. 3D and 3G). Similarly, since box 512 corresponds to the information from Inspector 2 (the above-described second peer on the issue relating to the character “E”), box 512 corresponds to the information of box 324 (FIG. 3J). In an analogous manner, box 514 corresponds to the information of box 402 (FIG. 4). Had another peer recognized that the character “E” related to an issue (here, identified as Inspector n), then the integrated (or updated) master issues database 214 would have information (represented by the box 516) corresponding to that peer's comment.

The author may then move the cursor over to a selected one of the boxes 310, 324 or 402, thereby causing the display of the issue comments provided by the peer. For example, as illustrated in FIG. 5C, selection of the box 310 causes a subsequent pop-up issue comments box 518 to display the issue comment and metadata from the first peer (Inspector 1, see also FIG. 3C). Accordingly, the author can quickly review all identified issues and review issue comments by scrolling and/or paging through the master peer review deliverable 216 integrated with the integrated (or updated) master issues database 214.

The above described process whereby the author may review the master peer review deliverable 216 integrated with the integrated (or updated) master issues database 214 may occur at any point in the peer review process. That is, the author may begin his review before all of the peers have finished their review since master issues database 214 is integrated (or updated) as each peer finishes their review (and the associated peer issue database is communicated to the author's processing system 202) for integration into the master issues database 214.

After reviewing the issue comments for an identified issue, the author may have devised a solution for the issue, or may otherwise have responding comments to the identified issue (referred to herein as the issues solution). Embodiments of the integrated peer review tool 100 provide a pop-up issue resolution comment box 520, as illustrated in FIG. 5D. The author completes the pop-up issue resolution comment box 520 in much the same manner as the above-described pop-up comment boxes 306, 314 (FIGS. 3C and 3F, respectively). When the author has completed the pop-up issue resolution comment box 520, the information is integrated into the master issues database 214, much like the above-described identified issues (and associated issue comments and metadata) provided by the peers. Some embodiments allow the author to complete a unique pop-up issue resolution comment box 520 for each of the individual issues comment provided by a peer, or, the pop-up issue resolution comment box 520 may generally apply to the identified issue. In some embodiments, the author may selectively provide an issues solution to selected issues comments.

Alternatively, the author may respond to an identified issue using the above-described issue database entry page 326 (FIG. 3K). Thus, the author may process the peer review comment by causing the integrated peer review logic 100 to generate a hard copy report of the issues and the issue comments, for example. The author may enter their responses directly into the master issues database 214 residing in their processing system 202. (Or, more likely, would give their responses to a proxy for entry directly into the master issues database 214.) Some embodiments of the integrated peer review tool 100 may support direct entry into the master issues database 214 by providing a displayed, interactive issue database entry page. Entry of various metadata of interest may also be allowed. In some embodiments, other metadata may be automatically determined.

In either of the above-described processes of entering an issue solution through the pop-up issue resolution comment box 520 or an issue database entry page, the issue solution is associated with the corresponding issue. Thus, if a plurality of issue comments from different peers are received during the peer review process pertaining to a common issue, the issue solution is therefore associated with those issue comments.

After the integrated peer review logic 100 has integrated (or updated) the master issues database 214 with the author's response, the author may again select the issue flag and view an updated pop-up issues box. For example, if the author selects the flag icon 504, as illustrated in FIG. 5B, an updated pop-up issues box 514 (FIG. 5E) is displayed that includes the new response from the author. Accordingly, the author can quickly review all identified issues and his responses, and review issue comments and response comments, by scrolling or paging through the master peer review deliverable 216 integrated with the integrated (or updated) master issues database 214 to include the author's responses.

FIG. 6 illustrates an integrated (or updated) master issues database 214 with the author's comments. It is understood that the illustrated boxes correspond to information regarding the identified issues. As noted above, when author's review is completed, the master issues database 214 is integrated (or updated) with the author's comment (proposed issues solution).

For this simplified illustrative example, assume that the author has provided issue solutions on two issues “A” and “Z” (denoted by blocks 602 and 604). Assume that “Issue A” corresponds to the first issue identified by the first, second and third peers (regarding the character “E”). Furthermore, assume that “Issue Z” corresponds to the second issue identified by the first and second peers (regarding the “SPDORG” phrase). To coordinate among the many issues identified by the plurality of peers, common issues may be identified with a unique identifier. Accordingly, the identifier “A” is used in this simplified example to indicate that the comments and the author's proposed issue solution (box 602) relates to the character “E” described above. Similarly, the identifier “Z” is used in this simplified example to indicate that the comments and the author's proposed issue solution (box 604) relates to the “SPDORG” phrase.

Since box 606 corresponds to the information from Inspector 1 (the above-described first peer on the issue relating to the character “E”), box 606 corresponds to the information of box 310 (FIGS. 3D and 3G). Similarly, since 608 corresponds to the information from Inspector 2 (the above-described second peer on the issue relating to the character “E”), box 608 corresponds to the information of box 324 (FIG. 3J). In an analogous manner, box 610 corresponds to the information of box 402 (FIG. 4) and box 612 corresponds to the information of box 416 (FIG. 3G).

Had another peer recognized that the “SPDORG” phrase related to an issue (here, identified as Inspector n), then the integrated (or updated) master issues database 214 would have information (represented by the box 614) corresponding to that peer's comment. Thus, the information of box 604 (corresponding to the author's proposed issue solution) would presumably address the comments of boxes 612 and 614.

Summarizing, the plurality of peer's issues databases 218A-i generated by the plurality of peers is communicated back to the author's processing system 202 (FIG. 2). During the updating of the master issue database 214, information (peer identity and the peers issue comment) pertaining to a common issue are associated together. As the author provides an issue solution for the common issue, that issue solution is associated with the common issue, thereby resulting in the association with the issue solution with the plurality of issue comments pertaining to the common issue.

In actual practice, an integrated (or updated) master issues database 214, upon conclusion of the author's review, will have many issue solutions. If the deliverable project is extremely large and complex, and if many peers are involved in the peer review process, there may be thousands of issue solutions.

As noted above, an integrated (or updated) master issues database 214 may be communicated back to a peer at any point during the peer review process. The peers may then interactively review information contained in the integrated (or updated) master issues database 214 by having portions of the peer review deliverable 140, or the deliverable 138, (FIGS. 1 and 2), integrated with information from the received integrated (or updated) master issues database 214, displayed on their display 126 (FIG. 1). Since an integrated (or updated) master issues database 214 may be communicated back to a peer at any point during the peer review process, author solutions may or may not be included, depending upon when in the peer review process the integrated (or updated) master issues database 214 is communicated to the peer. Similarly, the integrated (or updated) master issues database 214 is communicated to the peer may or may not contain all of the peer comments, again depending upon when in the peer review process the integrated (or updated) master issues database 214 is communicated to the peer.

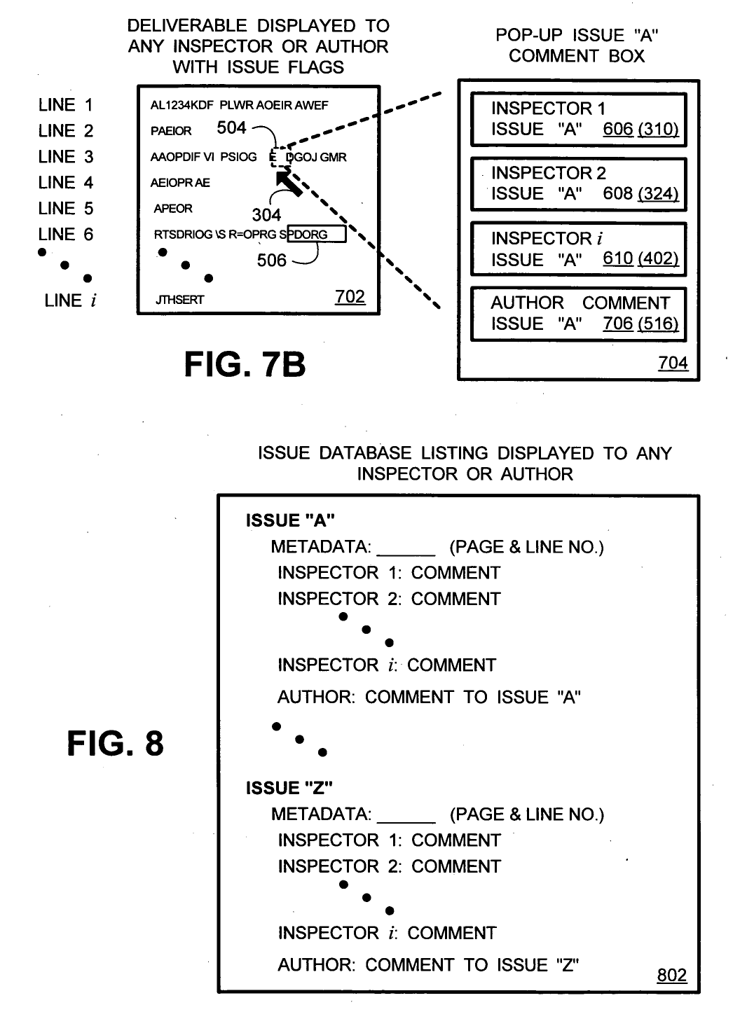

FIGS. 7A and 7B illustrate the peer's and the author's review process, after the author has provided issue solutions into the integrated (or updated) master issues database 214 (FIG. 2). Similar to the example of FIG. 5A, a portion of a peer review deliverable 702, integrated (or updated) with information in the integrated (or updated) master issues database 214, is illustrated in FIG. 7A. The image includes the issue flags 504 and 506. For convenience, only the first six lines (Line 1 to Line 6) and the last line (Line i) are illustrated. As the peer or the author reviews the displayed portion of the master peer review deliverable 702, the peer or author may page down and/or scroll down through the deliverable image to review individual lines.

When the peer or author selects the flag icon 504, as illustrated in FIG. 7B, a pop-up issue “A” comment box 704 is displayed. The flag icon 504 may be selected in any variety of manners, depending upon the embodiment. The peer or author selects an issue flag of interest by placing the pointer icon 304 over, or in proximity to, the issue flag 504, or by moving a cursor (not shown) to, or in proximity to, the issue flag 504, or by using another suitable selection process. Such actions signal the integrated peer review logic 100 to display the current pop-up issue comment box and the author's issue solution, if present, associated with that issue.

Here, the pop-up box 704 indicates that the character “E” was identified as an issue by the first, second and third peers in the above-described simplified example, and that the author provided an issue solution. If other peers had also indicated that the character “E” was an issue, they would also be identified in the pop-up box 704. In this exemplary embodiment, the issue associated with the character “E” is identified as issue “A” for convenience.

Since box 606 corresponds to the information from Inspector 1, box 606 corresponds to the information of box 310 (FIGS. 3D and 3G). Similarly, box 608 corresponds to the information from Inspector 2 and corresponds to the information of box 324 (FIG. 3J). In an analogous manner, box 610 corresponds to the information of box 402 (FIG. 4). Furthermore, since the author provided an issue solution to this issue, box 706 is displayed (where box 706 corresponds to box 516 of FIG. 5E).

The peer or author may then move the cursor over to a selected one of the boxes 606, 608 or 610, thereby causing the display of the issue comments provided by the peer. Or, the peer or author may move the cursor over to box 706, thereby causing the display of the issue solution provided by the author. Accordingly, the peer or author can quickly review all identified issues and issue solutions and review the issue comments and issue solutions by scrolling or paging through the portion of the peer review deliverable 702, integrated (or updated) with information in the integrated (or updated) master issues database 214 (FIG. 2).

After reviewing the issue comments and issue solutions, the peers or the author may have add additional comments, or may even provide issues solution alternatives or issue solution enhancements. Embodiments of the integrated peer review tool 100 provide pop-up issue resolution comment boxes, or an issue resolution comment box, as described above to facilitate entry for additional issue comments or issue solutions.

FIG. 8 illustrates a printable version of the issues comments and the provided issue solutions. The printout 802 illustrates a general format that may be selected for design of a printout of the issues comments and the provided issue solutions that are determined during the peer review process.

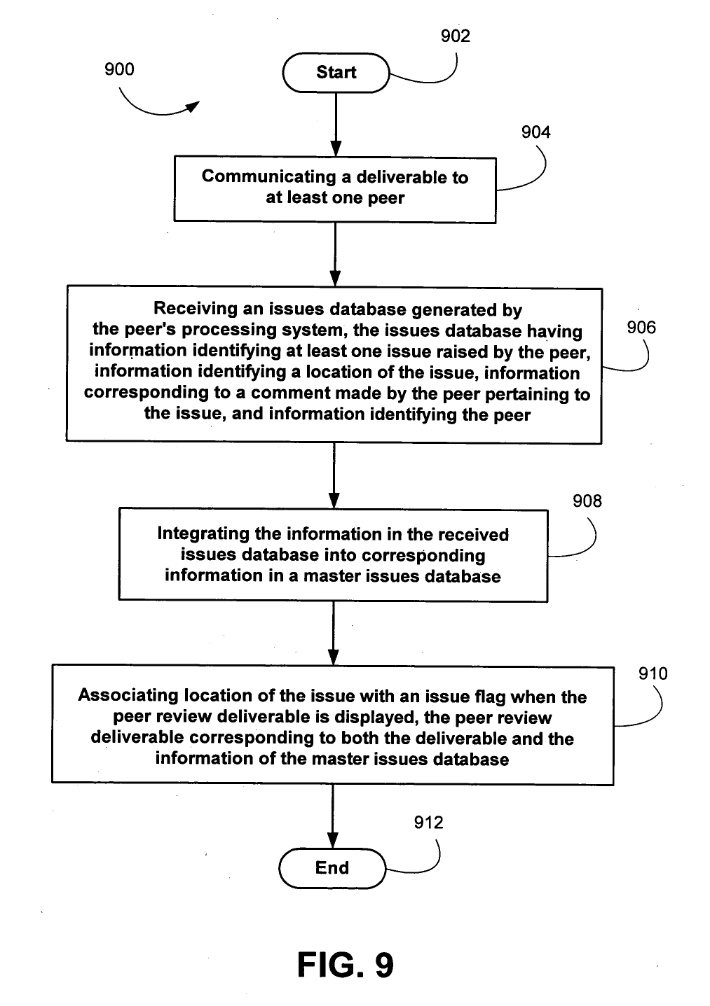

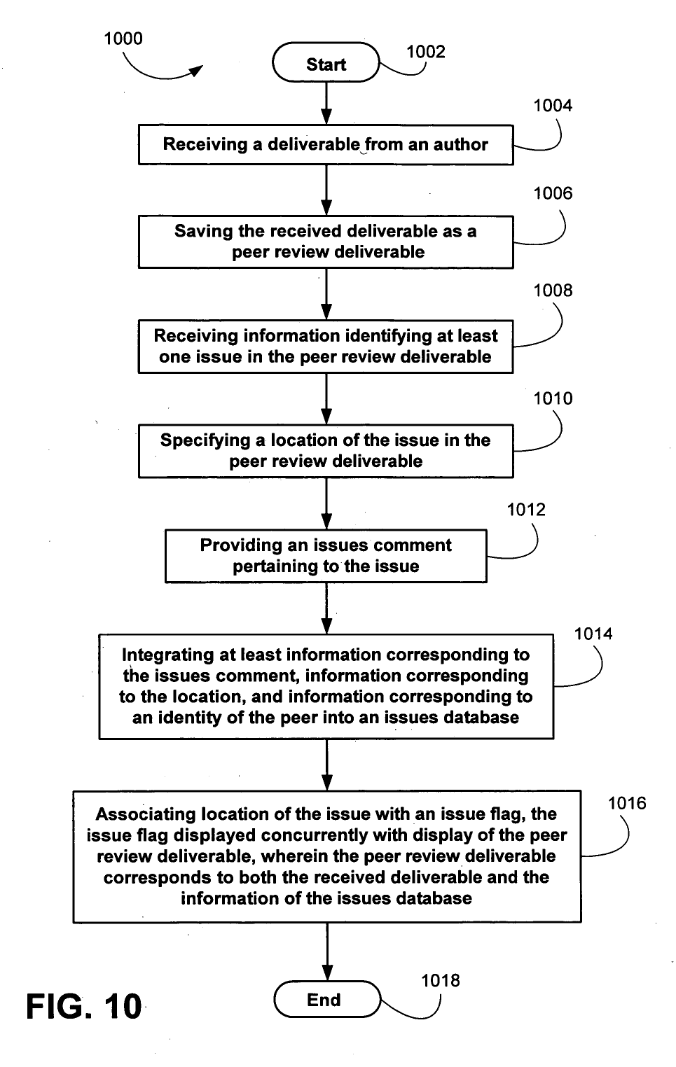

FIG. 9 is a flowchart illustrating an embodiment of a process for facilitating peer review of a deliverable by the an author. FIG. 10 is a flowchart illustrating an embodiment of a process for facilitating peer review of a deliverable by the a peer.

The flow charts 900 and 1000 of FIGS. 9 and 10, respectively, show the architecture, functionality, and operation of an embodiment for implementing embodiments of the integrated peer review logic 104 (FIGS. 1 and 3). An alternative embodiment implements the logic of flow charts 900 and 1000 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 9 or 10, or may include additional functions. For example, two blocks shown in succession in FIG. 9 or 10 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process illustrated by the flow chart 900 (FIG. 9) begins at block 902. At block 904, a deliverable is communicated to at least one peer. At block 906, an issues database generated by the peer's processing system is received, the issues database having information identifying at least one issue raised by the peer, information identifying a location of the issue, information corresponding to a comment made by the peer pertaining to the issue, and information identifying the peer. At block 908, the information in the received issues database is integrated into corresponding information in a master issues database. At block 910, location of the issue is associated with an issue flag when the a peer review deliverable is displayed, the peer review deliverable corresponding to both the deliverable and the information of the master issues database. The process ends at block 912.

The process illustrated by the flow chart 1000 (FIG. 10) begins at block 1002. At block 1004, a deliverable is received from an author. At block 1006, the received deliverable is saved as a peer review deliverable. At block 1008, information identifying at least one issue in the peer review deliverable is received. At block 1010, a location of the issue in the peer review deliverable is specified. At block 1012, an issues comment pertaining to the issue is provided. At block 1014, at least information corresponding to the issues comment, information corresponding to the location, and information corresponding to an identity of the peer is integrated into an issues database. At block 1016, location of the issue is associated with an issue flag, the issue flag displayed concurrently with display of the peer review deliverable, wherein the peer review deliverable corresponds to both the received deliverable and the information of the issues database. The process ends at block 1018.

Embodiments of the integrated peer review tool 100 implemented in memory 106 (FIG. 1) and/or the memory residing in a peer's processing system (FIG. 2) may be implemented using any suitable computer-readable medium. In the context of this specification, a “computer-readable medium” can be any means that can store, cornmunicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

In the various embodiments, the above described deliverable 138 is received by embodiments of the integrated peer review tool logic 104 (FIGS. 1 and 2), and then is separately saved as the peer review deliverable 140. Accordingly, the peer review deliverable 140 is a separate document or separate data that is within the domain of and/or express control of the integrated peer review tool logic 104. Thus, the integrated peer review tool logic 104 may associate information pertaining to issue comments and issue solutions by modifying peer review deliverable 140. The deliverable 138 is not modified during the peer review process since it is a separate document.

It should be emphasized that the above-described embodiments are merely examples of the disclosed system and method. Many variations and modifications may be made to the above-described embodiments. All such modifications and variations are intended to be included herein within the scope of this disclosure.

What is claimed is:

1. A method for facilitating peer review of a deliverable, comprising:
communicating the deliverable to at least one peer;
receiving an issues database generated by a peer's processing system, the issues database having information identifying at least one issue raised by the peer, information identifying a location of the issue, information corresponding to a comment made by the peer pertaining to the issue, and information identifying the peer;
integrating the information in the received issues database into corresponding information in a master issues database; and
associating the location of the issue with an issue flag when a peer review deliverable is displayed, the peer review deliverable corresponding to both the deliverable and the information of the master issues database.

2. The method of claim 1, wherein associating the location of the issue with the issue flag further comprises displaying the issue flag on a display concurrently with the displayed peer review deliverable, wherein the location of the displayed issue flag indicates the location of the issue in the peer review deliverable.

3. The method of claim 1, further comprising displaying a pop-up issue comment box that indicates an identity of the peer and that indicates the comment pertaining to the issue, the pop-up issue comment box corresponding to the issue flag.

4. The method of claim 3, wherein the pop-up issue comment box is displayed when a pointer icon is positioned in proximity to the displayed issue flag.

5. The method of claim 3, wherein the pop-up issue comment box is displayed when a cursor is positioned in proximity to the displayed issue flag.

6. The method of claim 1, further comprising receiving information corresponding to an issue solution, the issue solution pertaining to the issue.

7. The method of claim 6, further comprising:
displaying a pop-up issue resolution comment box; and
interactively receiving the issue solution from an author via the displayed pop-up issue resolution comment box.

8. The method of claim 7, further comprising associating the issue solution with the issue.

9. The method of claim 6, further comprising displaying an issue database entry page such that an author can enter the issue solution via the issue database entry page, and such that the issue solution is associated with the issue when the author specifies a location in the peer review deliverable that corresponds to the location of the issue.

10. The method of claim 6, further comprising displaying an issue database entry page such that an author can enter the issue solution via the issue database entry page, and such that the issue solution is associated with the issue when the author specifies a location in the deliverable that corresponds to the location of the issue.

11. The method of claim 6, further comprising integrating the issue solution with the corresponding information in the master issues database such that the comment and the issue solution are associated with the issue.

12. The method of claim 11, further comprising displaying a pop-up issues box when a pointer icon is positioned in proximity to the displayed issue flag, wherein the pop-up issues box displays at least an identity of the peer who raised the issue and an identity of an author who provided the issue solution.

13. The method of claim 12, further comprising displaying the issue comment provided by the peer when the pointer icon is positioned in proximity to the displayed identity of the peer.

14. The method of claim 12, further comprising displaying the issue solution provided by the author when the pointer icon is positioned in proximity to the displayed identity of the author.

15. The method of claim 11, further comprising:
communicating the master issues database to the peer; and
displaying the issue solution to the peer.

16. The method of claim 1, further comprising:
receiving a plurality of issues databases generated by a plurality of peers, each issues database having the information pertaining to the issue; and
integrating the information in the received issues databases into the corresponding information in the master issues database, wherein information pertaining to a common issue are associated.

17. The method of claim 16, wherein the information pertaining to the common issue includes information identifying each of the plurality of peers who raised the common issue and information corresponding to the issue comment made by the peer pertaining to the common issue.

18. The method of claim 16, further comprising:
concurrently displaying the peer review deliverable and at least one issue flag; and
displaying a pop-up issues box when a pointer icon is positioned in proximity to the displayed issue flag, wherein the pop-up issues box displays a plurality of identities of the plurality of peers who each raised the common issue associated with the issue flag.

19. The method of claim 16, further comprising communicating the integrated master issues database to the plurality of other peers such that other peers may review all of the issue comments and the issue solution.

20. A system for facilitating peer review of a deliverable, comprising:
means for communicating the deliverable to at least one peer;
means for receiving an issues database generated by a peer's processing system, the issues database having information identifying at least one issue raised by the peer, information identifying a location of the issue, information corresponding to a comment made by the peer pertaining to the issue, and information identifying the peer;
means for integrating the information in the received issues database into corresponding information in a master issues database; and
means for displaying an issue flag concurrently with display of a peer review deliverable, the peer review deliverable corresponding to both the deliverable and the information of the master issues database.

21. The system of claim 20, further comprising:
means for displaying a pop-up issue resolution comment box; and
means for interactively receiving an issue solution from an author via the displayed pop-up issue resolution comment box.

22. The system of claim 21, further comprising means for associating the issue solution with the issue.

23. The system of claim 20, further comprising means for displaying an issue database entry page such that an author can enter an issue solution via the issue database entry page, and such that the issue solution is associated with the issue when the author specifies the location in the peer review deliverable that corresponds to the location of the issue.

24. The system of claim 20, further comprising means for displaying an issue database entry page such that an author can enter an issue solution via the issue database entry page, and such that the issue solution is associated with the issue when the author specifies a location in the deliverable that corresponds to the location of the issue.

25. A method for facilitating peer review of a deliverable, comprising:
receiving the deliverable from an author;
saving the received deliverable as a peer review deliverable;
receiving information identifying at least one issue in the peer review deliverable;
specifying a location of the issue in the peer review deliverable;
providing an issues comment pertaining to the issue;
integrating at least information corresponding to the issues comment, information corresponding to the location, and information corresponding to an identity of the peer into an issues database; and
associating location of the issue with an issue flag, the issue flag displayed concurrently with display of the peer review deliverable, wherein the peer review deliverable corresponds to both the received deliverable and the information of the issues database.

26. The method of claim 25, wherein specifying the location of the issue further comprises positioning a pointer icon in proximity to a location on the displayed peer review deliverable.

27. The method of claim 25, wherein specifying the location of the issue further comprises positioning a cursor in proximity to a location on the displayed peer review deliverable.

28. The method of claim 25, wherein specifying the location of the issue further comprises specifying a location on the peer review deliverable using an issue database entry page.

29. The method of claim 25, wherein specifying the location of the issue further comprises specifying a location on the deliverable using an issue database entry page.

30. The method of claim 25, wherein providing the issues comment further comprises entering the issues comment using an issue database entry page.

31. The method of claim 25, wherein providing the issues comment further comprises:
displaying a pop-up issue comment box; and
receiving the issues comment from the peer via the displayed pop-up issue comment box.

32. The method of claim 31, further comprising displaying the issue flag on the displayed peer review deliverable, wherein the location of the issue flag corresponds to the location of the issue.

33. The method of claim 25, further comprising:
communicating the issues database to the author; and
receiving an updated master issues database from the author, the updated master issues database having information corresponding to a plurality of issues identified by a plurality of other peers, and having a plurality of issue solutions pertaining to the plurality of issues.

34. The method of claim 33, further comprising:
integrating the information of the updated master issues database with the peer review deliverable;
displaying the integrated peer review deliverable; and
indicating location of the each of the plurality of issues with a unique issue flag.

35. The method of claim 34, further comprising displaying a pop-up issues box when a pointer icon is positioned in proximity to a selected issue flag, wherein the pop-up issues box indicates at least an identity of each of the plurality of peers providing the issue comments pertaining to the issue corresponding to the selected issue flag.

36. The method of claim 35, wherein displaying the pop-up issues box further indicates that the author has provided a proposed issue solution pertaining to the issue corresponding to the selected issue flag.

37. The method of claim 36, further comprising;
selecting one of the plurality of other peers or the author by positioning the pointer icon in proximity to the identity of one of the plurality of other peers or the author; and
displaying a pop-up issues comment box corresponding to the selected one of the plurality of other peers or the author, wherein the pop-up issues comment box indicates the issue comment when one of the other peers is selected or indicates the issue solution when the author is selected.

38. The method of claim 25, wherein integrating further comprises integrating metadata into the issues database.

39. A program for facilitating peer review of a deliverable, the program stored on computer-readable medium and comprising:
logic for communicating the deliverable to a plurality of peers;
logic for receiving a plurality of issues databases, each issues database generated by a processing system used by the peers, wherein each of the issues databases has information identifying at least one issue raised by the peer, information identifying a location of the issue, information corresponding to a comment made by the peer pertaining to the issue, and information identifying the peer;
logic for integrating the information in the received issues databases into corresponding information in a master issues database; and
logic for displaying an issue flag that corresponds to an issue, such that when a peer review deliverable is displayed, issue flags identify the location of each one of the issues.

40. The program of claim 39, further comprising:
logic for displaying a pop-up issue resolution comment box; and
logic for interactively receiving an issue solution from an author via the displayed pop-up issue resolution comment box.

41. The program of claim 39, further comprising logic for associating the issue solution with the issue.

42. The program of claim 39, further comprising logic updating the master issues database with an issues solution.

43. The program of claim 39, further comprising logic for communicating the integrated master issues database to the plurality of peers.
